(19) United States
(12) Patent Application Publication
(10) Pub. No.: US 2015/0205581 A1
(43) Pub. Date: Jul. 23, 2015

(54) METHOD FOR CREATING A CENTRALLY LOCATED ENTERPRISE SERVICE APPLICATION FRAMEWORK

(71) Applicant: Bejoynath L. Narayanapillai, Coppell, TX (US)

(72) Inventor: Bejoynath L. Narayanapillai, Coppell, TX (US)

(21) Appl. No.: 14/161,559

(22) Filed: Jan. 22, 2014

(51) Int. Cl. G06F 9/44; G06Q 10/06; G06Q 10/10

(52) U.S. Cl. CPC G06F 8/20; G06Q 10/101; G06Q 10/063

(57) ABSTRACT

A method for creating enterprise service applications may include a creating a sponsoring organization, creating a set of core business native applications through the sponsoring organization, declaring a set of application programming interfaces for the set of core business native applications, hosting a store for at least one developer to develop custom enterprise applications, evaluating submitted custom enterprise applications by the at least one developer, and providing access to the approved submitted custom enterprise applications and core business native applications through the store. Subscribing customers may evaluate and subscribe to any of the submitted custom enterprise applications and core business native applications and combinations thereof.

### BACKGROUND OF THE INVENTION

The present invention relates to service applications and, more particularly, to a method for creating enterprise service applications.

Business processes are very country/location specific and industry specific. It is difficult for one company or organization to make software that meets all these varied needs. Providers try to build functionality for all different industries in all parts of the world. However there are always nuanced differences in the way companies work. These unique requirements are usually met by running multiyear, multimillion dollar implementation projects that focus on configuring the packaged software and making enhancements. There are also service providers that provide enterprise services over the cloud. The cloud based solutions have two major limitations: 1) the cloud based solutions are limited in functionality because the service provider is not able to provide configuration options that support all varied business needs. and 2) one organization is very unlikely to have the required business process and localization knowledge required to support all the varied business needs required above. For these two reasons, typically the cloud based solutions are focused on process area such as Sales or Procurement and does not provide a platform that supports all the business processes of an organization.

Currently existing business application providers build the entire application set that an organization needs or make application sets for individual business processes—eg: Purchasing. This leads to a situation where extensive customizing is needed for each individual customer. This is a massive waste of labor and resources. One organization trying to build applications for all needs is not practical as businesses in different parts of the world and across industries follow business processes that are significantly divergent. This kind of software requires massive customizing at each customer. This is a waste of resources.

By having a system where certain core functionality is supported using native applications, and other nuanced functionality using custom applications, this problem of wasted resources can be avoided. Currently the configurations and programmers that add functionality for each customer are not able to package and resell their effort to customers with similar requirements.

As can be seen, there is a need for method for creating enterprise service applications in a collaborative fashion, wherein there is one provider who provides a set of core applications and declares application programming interfaces (API) used for and by these core applications.

### SUMMARY OF THE INVENTION

In one aspect of the present invention, a method for creating enterprise service applications comprises: creating a sponsoring organization; creating a set of core business native applications through the sponsoring organization; declaring a set of application programming interfaces for the set of core business native applications; hosting a store for at least one developer to develop custom enterprise applications; evaluating submitted custom enterprise applications by the at least one developer; and providing access to the approved submitted custom enterprise applications and core business native applications through the store.

These and other features, aspects and advantages of the present invention will become better understood with reference to the following drawings, description and claims.

### BRIEF DESCRIPTION OF THE DRAWINGS

FIG. 1 is a block diagram of an exemplary embodiment of the present invention.

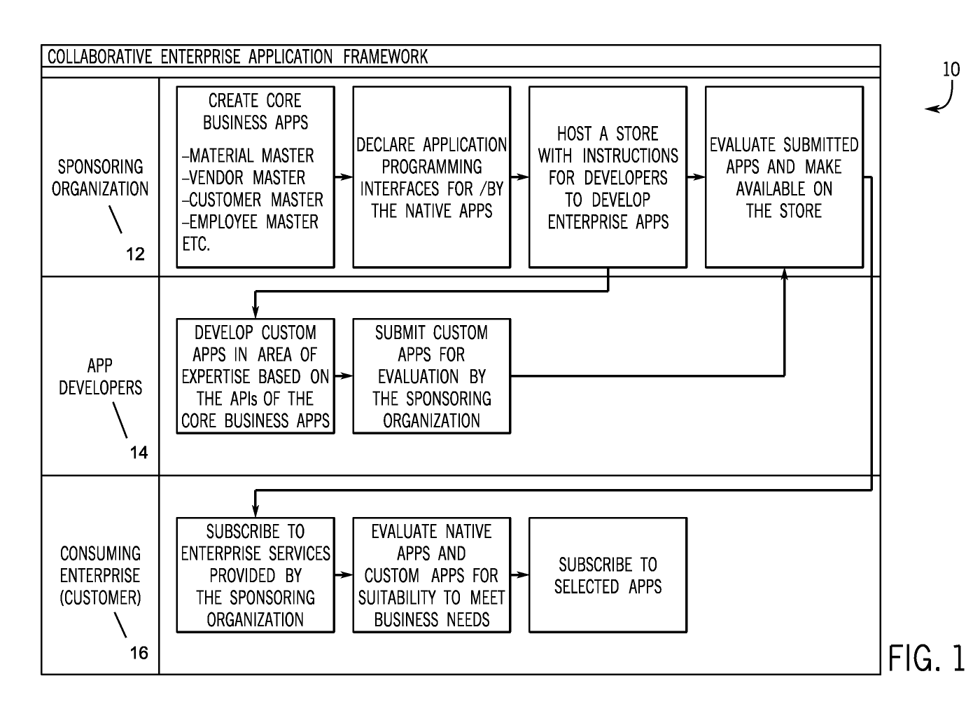

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for creating enterprise service applications that may include a creating a sponsoring organization, creating a set of core business native applications through the sponsoring organization; declaring a set of application programming interfaces for the set of core business native applications; hosting a store for at least one developer to develop custom enterprise applications; evaluating submitted custom enterprise applications by the at least one developer; and providing access to the approved submitted custom enterprise applications and core business native applications through the store. Subscribing customers may evaluate and subscribe to any of the submitted custom enterprise applications and core business native applications and combinations thereof.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

As is illustrated in the Figure, the present invention may include a sponsoring organization 12 that may provide an application framework 10 that may include core business native applications. Only a small number of core business native applications may be required to support the business requirements of a wide range of organizations. The core business native applications may include, but are not limited to: Material master—a record of the various materials used by an organization, Vendor Master—A record of various suppliers of an organization, Customer Master—A record of the customers of an organization, Chart of Accounts—a listing of the general ledger accounts used by a legal entity, and the like. While on the surface there are lots of differences between the business processes of various organizations, at the core there are few business processes which are very identical. This then means that the sponsoring organization can create a small finite number of native applications that may make the envisioned model for delivering enterprise services viable.

In certain embodiments, the sponsoring organization 12 may create application programming interfaces (APIs) used for and by these core business native applications. The core business native applications by themselves may not be sufficient to support the business processes required by most enterprises. A community of at least one developer 14 with specialized knowledge of various industries and regions may create custom apps using the above mentioned APIs. The sponsoring organization 12 may provide the application framework 10 that may include a secure way of storing data, monitoring and may host all the native app and custom app services. Then the sponsoring organization 12 may create a store and a set of guidelines for any developer 14 to create and sell custom enterprise applications for particular businesses. The store may be located online and require at least one computer with a user interface to access. These custom enterprise applications may only interact with the core business native applications in ways provided by the above mentioned APIs. The submitted custom enterprise applications may be evaluated and then made available on the store. The sponsoring organization 12 may then sell this as a solution application framework 10 to any organization that may want to buy software as service solutions.

By providing an application framework 10 where a set of core business native applications and a set of custom enterprise applications work together, the limitation listed above may be resolved. For example, Material Master, Vendor Master, Chart of accounts and the like may be core business native applications with defined application programming interfaces. In certain embodiments, an aluminum manufacturer may have a need to create a purchase order that automatically change price when the average market price of aluminum for the previous month is known and recorded. At least one developer 14 with knowledge of this business process may be able to create a custom enterprise application that may be called ‘Aluminum Purchase Order’. This custom enterprise application may be accessing the APIs to the core business native applications mentioned above to get the material master, vendor master and the like.

In certain embodiments, a company may want to have their finance, materials management and sales systems in this application framework 10 they may look for all competing custom enterprise applications that meet its need. In certain embodiments, a company may decide to buy one custom enterprise application for creating purchase orders for buying material from one of its own plants, another custom enterprise application for creating a purchase order where some materials are shipped to the vendor for assembling, and another custom enterprise application that specifically supports functionality needed for procuring services such as the vendor being able to suggest substitutes. In all these examples, custom enterprise applications may have used APIs to the core business native applications to access vendor master, material master. GL accounts and the like.

In certain embodiments, a company may not able to find a custom enterprise application that meets its needs. The company may develop at least one custom enterprise application on its own in this situation. The developer 14 of this custom enterprise application may also have the option to sell this custom enterprise application to others. A company may become a customer 16 that may subscribe to the enterprise services provided by the sponsoring organization 12. The customer 16 may evaluate core business native applications and custom enterprise applications for suitability to meet the business needs of the customer 16. The customer 16 may then subscribe to the selected applications.

A determination may be made as to what core business native applications may be built. The primary core business native applications may be the master records, such as material master, vendor master, customer master, GL accounts, employee masters and the like. A determination may be made as to the APIs needed for each of the above core business native applications. Documentation and an application framework 10 may be provided to anyone that may build custom enterprise applications that access data based on the above mentioned core business native applications. In certain embodiments, custom enterprise applications may be used. Application Programming Interfaces that allow one custom enterprise application to interact with another custom enterprise application may also be used.

A method of using the present system may include the following. A person or sponsoring organization 12 may build a set of core business native applications that are necessary for any IT applications for a business, such as material master, vendor master, customer master and the like. Then APIs may be created and documented for these core business native applications. Thirdly documentation and an application framework 10 may be provided for building custom enterprise applications using these APIs. A store may be sponsored where developers of these custom enterprise applications may sell these custom enterprise applications to customers 16. In certain embodiments, a sponsoring organization 12 may create a set of core business native applications for business with the intention that other parties may create custom enterprise applications to meet varied needs of different businesses across the globe. Customers 16 may subscribe to the enterprise services provided in the store from the sponsoring organization 12.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for creating a centrally located enterprise service application framework comprising:
creating a sponsoring organization;
creating a set of core business native applications through the sponsoring organization;
declaring a set of application programming interfaces for the set of core business native applications;
hosting a store for at least one developer to develop custom enterprise applications;
evaluating submitted custom enterprise applications by the at least one developer; and
providing access to the approved submitted custom enterprise applications and core business native applications through the store.

2. The method of claim 1, further comprising the step of developing a set of custom enterprise applications in areas of expertise based on the set of application programming interfaces of the set of core business native applications by at least one developer.

3. The method of claim 2, further comprising the step of submitting the set of custom enterprise applications for evaluation by the sponsoring organization.

4. The method of claim 1, further comprising the step of subscribing customers to a set of enterprise services provided by the sponsoring organization.

5. The method of claim 4, further comprising the step of evaluating the set of core business native applications and the set of custom enterprise applications for suitability to meet the business needs of the subscribing customers.

6. The method of claim 5, further comprising the step of subscribing to the set of selected core business native applications and the set of custom enterprise applications by the subscribing customer obtaining the set of enterprise services.
